(19) United States
(12) Patent Application Publication
(10) Pub. No.: US 2013/0211892 A1
(43) Pub. Date: Aug. 15, 2013

(54) Method and Apparatus to Increase a Cash Line Limit

(71) Applicants: Rob Frohwein, Atlanta, GA (US); Troy Deus, Atlanta, GA (US)

(72) Inventors: Rob Frohwein, Atlanta, GA (US); Troy Deus, Atlanta, GA (US)

(73) Assignee: KABBAGE, INC., Atlanta, GA (US)

(21) Appl. No.: 13/767,161

(22) Filed: Feb. 14, 2013

Related U.S. Application Data
(60) Provisional application No. 61/598,542, filed on Feb. 14, 2012.

(51) Int. Cl. G06Q 30/02; G06Q 50/00

(52) U.S. Cl. CPC G06Q 30/0214; G06Q 50/01
USPC 705/14.16; 705/14.17

(57) ABSTRACT

A method, apparatus, and computer readable storage to provide a cash line from a cash provider to a user in which the user is permitted to withdraw cash from the cash line. The cash line can be automatically increased by the user taking certain actions, such as the user friending the cash provider on a social networking site such as FACEBOOK. The cash line can also be increased if the user provides an email address of a user's friend and that friend actually signed up with the cash provider and receives their own cash line.

### CROSS REFERENCE TO RELATED APPLICATIONS

This Application claims benefit to provisional application 61/598,542, which is incorporated by reference herein in its entirety.

### BACKGROUND OF THE INVENTION

1. Field of the Invention

The present inventive concept relates to a system, method, and computer readable storage that provides a method, apparatus and computer readable storage to offer a user a cash line and allow the user to take actions to increase their cash line. As used herein, a cash line could be a credit line, a merchant cash advance line (based on receivables flow), a loan, or some other type of working capital line.

2. Description of the Related Art

U.S. Pat. No. 7,983,951 (to Frohwein) describes a way that a person (or organization) can receive cash loans or advances electronically. An amount of such a loan or advance can be determined automatically using an algorithm. The cash provider in this case benefits from making these loans/advances because they would typically get repaid the principal plus interest or commission.

Social networking is growing at an exponential rate and businesses that are not exploiting social networking sites such as FACEBOOK and LINKEDIN are considered falling behind the times.

What is needed is a way in which a cash provider that provides cash lines can get greater exposure and referrals across social networking sites and the Internet in general.

### SUMMARY OF THE INVENTION

It is an aspect of the present general inventive concept to provide incentives to recipients of cash lines to take actions that benefit a provider of the cash lines.

The above aspects can be obtained by a system that includes (a) approving, by a cash provider, a user for a cash line wherein the user is permitted to receive cash up to the cash line; (b) causing an offer to be displayed on an electronic output device associated with a user's computer, the offer being to increase the cash line when the user takes a particular action comprising associating the user's social networking account with the cash provider; (c) determining that the user has taken the particular action; and (d) automatically increasing the cash line.

The above aspects can also be obtained by a system that includes (a) approving, by a cash provider, a user for a cash line wherein the user is permitted to receive cash up to the cash line; (b) causing an offer to be displayed on an electronic output device associated with a user's computer, the offer being to increase the cash line when a sequence is completed, the sequence comprising the user referring a friend of the user and the friend registering with the cash provider; (c) determining that the user has taken the particular action; and (d) automatically increasing the cash line.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating some participants on a network, according to an embodiment;

FIG. 2 is a screen shot illustrating one way to offer user actions to raise their cash line, according to an embodiment;

FIG. 3 is a flowchart illustrating an exemplary method of allowing a user to raise their cash line, according to an embodiment;

FIG. 4 is a flowchart illustrating a method of determining if a user associated one of their social networking accounts with the cash provider, according to an embodiment;

FIG. 5 is a flowchart illustrating a method of determining if a user's referral email address satisfies a sequence to complete an action thereby raising a cash line, according to an embodiment; and

FIG. 6 is a block diagram illustrating components needed to implement a digital computer that can be used to implement the methods described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

This Application is also related to non-provisional application Ser. Nos. 13/311,506, 13/159,080 12/436,642, and U.S. Provisional application 61/156,865, filed in the USPTO on Mar. 2, 2009. All four of these applications (Ser. Nos. 13/311,506; 13/159,080; 12/436,642; 61/156,865) are incorporated by reference in their entireties for all purposes.

A cash line (or limit) can be offered to a user who meets predefined criteria (or criterion) based on their respective risk. See U.S. application Ser. No. 13/175,184, filed on Jul. 1, 2011, (which is incorporated by reference herein in its entirety for all purposes), for a description of offering cash lines to users. “User” as used herein can refer to “seller” as used in application Ser. No. 13/175,184. While the Ser. No. 13/175,184 application describes offering a cash line to a seller on an e-commerce site, all embodiments herein can be applied to that paradigm or any other such scenario where a cash provider is offering a cash line to a user. A cash line can be offered to a user based on an evaluation of the user's characteristics, and if the user is approved for a cash line, then an amount of the cash line is also determined based on the user's characteristics. Of course, if a user is more credit-worthy then the user (which can be determined using any of the methods described herein or any document incorporated by reference) would be offered a higher line cash line.

Once a cash line is offered to a user, the user is able to tap (withdraw cash from) the cash line as the user wishes (until the user has no cash line left). For example, if the user is offered a $5,000cash line, the user may a) withdraw the entire $5,000all at once (upon which nothing is left to further draw from); or b) withdraw only $2,500 (or any other amount less than equal $5,000) and not use the remaining available cash (upon which the remainder is still available); or c) withdraw only $2,000 (or any other amount less than equal $5,000) and then a month later withdraw another $1,000 and then another month later withdraw the remaining $2,000 (which results in $0 of the cash line left). The cash line is like a credit limit on a credit card, it can be tapped as needed until the cash line is reached.

Of course, the user is responsible for making periodic (e.g., monthly) payments to a cash provider offering the cash line in accordance with a prior agreement between the user and the cash provider. “Cash provider” as used herein is synonymous with “cash line provider.”

It is typically in the user's interest to increase his or her cash line provided by the cash provider as much as possible, thus allowing the user access to as much cash as possible (it is the user's decision whether to take all or some of the cash line). Embodiments of the invention provide opportunities for the user who has already been offered a cash line to increase the cash line by taking certain actions that typically benefit the cash provider. Typically, when the cash line is increased in this fashion, a new approval process is not necessary (although in an alternative embodiment the approval process is repeated all over again for the user).

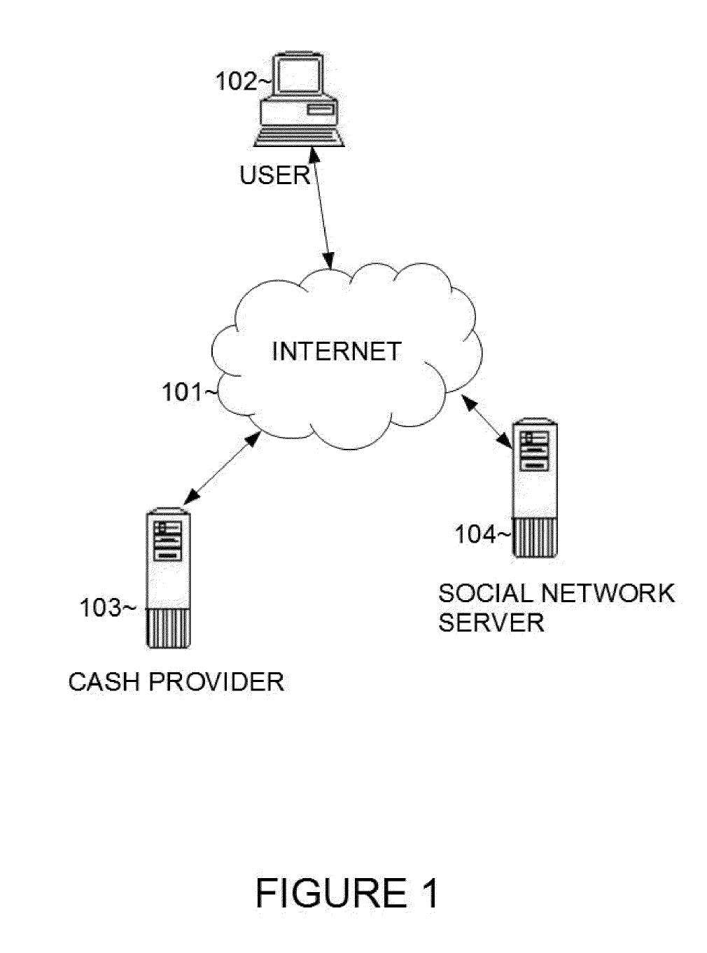

FIG. 1 is a block diagram illustrating some participants on a network, according to an embodiment.

A computer communications network such as the Internet 101 is used to connect different participants on the network. A user 102 is a party who is offered a cash line by a cash provider 103. The user can, for example, be a seller on an e-commerce web site who is offered the cash line based on the user's characteristics on the e-commerce web site (as described in application Ser. No. 13/175,184). The social network server 104 hosts a social networking site (e.g., FACEBOOK, TWITTER, etc.) which can be used by the user 102 to carry out an action which can increase the user's cash line provided by the cash provider 103.

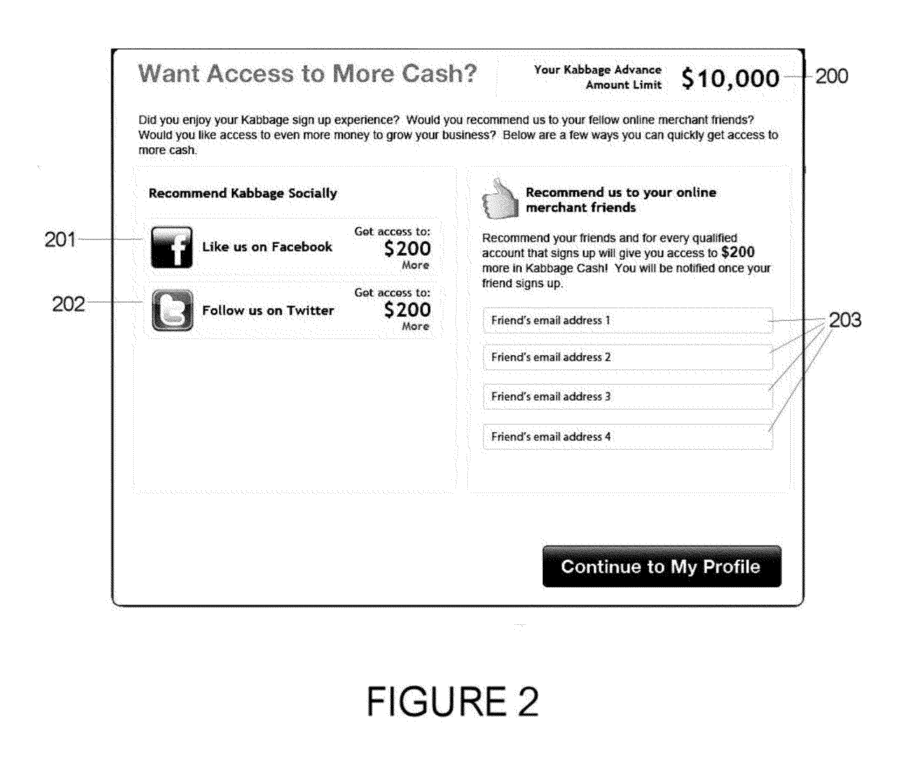

FIG. 2 is a screen shot illustrating one way to offer user actions to raise their cash line, according to an embodiment.

A cash line 200 is offered to a user (in this case $10,000 but of course this can be any other amount). The user can raise their cash line by using their account on a social networking site to associate their account with an account associated with the cash provider. The association can be done in numerous ways, for example liking the cash provider on FACEBOOK or following the cash provider on TWITTER. Liking the cash provider entails the user logging into the user's account on FACEBOOK and clicking a “like” button on a page associated with the cash provider. Typically FACEBOOK tracks (and published) how many people using FACEBOOK “like” a particular page, and it is in a page owner's interest to have more people who “like” the page. “Following” the cash provider on TWITTER entails the user logging into their account on TWITTER and click a “follow” button associated with the cash provider (or through other mechanisms enabling the follow) so that the user is “following” the cash provider (which means that any status updates that the cash provider enters is broadcasted to all of the its followers). It is in a TWITTER user's interest to have more followers, since more followers encourages more people to follow that user and/or demonstrates that user's influence online.

The user is offered a first way to raise their cash line 201 by “liking” the cash provider on FACEBOOK (or other social networking site). The user is offered a second way to raise their cash line 202 by “following” the cash provider on TWITTER (or other social networking site). These two ways can be considered associating the user's account with an account associated with the cash provider on a social networking site. While these two methods are described herein (liking, following) other methods can also be used to associate a cash provider on a social networking site.

Thus, as illustrated in FIG. 2, if this user logs into his or her FACEBOOK account and likes the cash provider (e.g., liking the page associated with the cash provider), the user's cash line will be raised from $10,000 to $10,200. If the user logs into his or her TWITTER account and follows the cash provider, then the user's cash line will be increased by $200. If the user performs both of these actions, then the user's cash line will be increased by $400 ($200 for each action).

Another way the user can have their cash line increased is by recommending the cash provider to the user's friends. The user can enter their friends' email addresses (also known as referral email addresses) in an input area 203 on the screen for email addresses. For each friend's email address that the user enters, the cash provider will send that friend an introductory email introducing the cash provider to that person and offering the person an opportunity to sign up with the cash provider. The cash provider can increase the user's cash line by $200 (or any other amount) for each email address the user provides that results in the friend actually signing up with the cash provider (raising the cash line may also require the person to actually receive money from the cash provider). Also, additional cash in the cash line can be made available for other actions of the friend in addition to such friend signing up (e.g., based on the amount of cash that is made available to the friend, the amount that the friend utilizes under the line, the ability of the friend to get other people to sign up for or take cash lines from the cash provider like a multi-level marketing program). Email addresses entered by the user in the input area 203 that do not result in the owners of those email addresses signing up will not result (although in another embodiment it still will result) in an increase in the user's cash line (although there may be some other benefit provided such as some additional cash line or a gift card, as an examples). The cash provider may institute a limit (e.g., 5) to the number of email addresses that the user can enter that will result in cash line increases (e.g., after a user enters 5 friends which all sign up and result in cash line increases equaling a total cash line raise of $200 time 5 or $1,000) then the user will not be allowed to increase their cash line any more in this manner (by entering friends email addresses) or may be restricted for some period of time. Also, cash lines may be lowered if such friends decide to cancel their account.

In addition to providing email addresses, other ways can be used for a user to refer their friends. For example, a friend can review their friend list and simply click the names of their friends they wish to refer. Alternatively, instead of typing the friends' email address, the user can type in their friends' real names or username on a social networking site.

It is noted that the user can raise their cash line limit in these manners without the user having to be subjected to another credit check/evaluation as required in order to approve the user for a cash line and determine the initial cash line amount ($10,000).

In the example illustrated in FIG. 2, “KABBAGE” is the name of the cash provider and the user would like the “KABBAGE” page to earn the $200 increase in cash line. The user would find the KABBAGE TWITTER profile on TWITTER and follow that to earn another $200 increase (in addition to the $200 from liking on FACEBOOK). The user could also enter a referral email in the input area 203 and if their friend registers on KABBAGE and is approved for a cash line then this would earn them another $200 cash line increase.

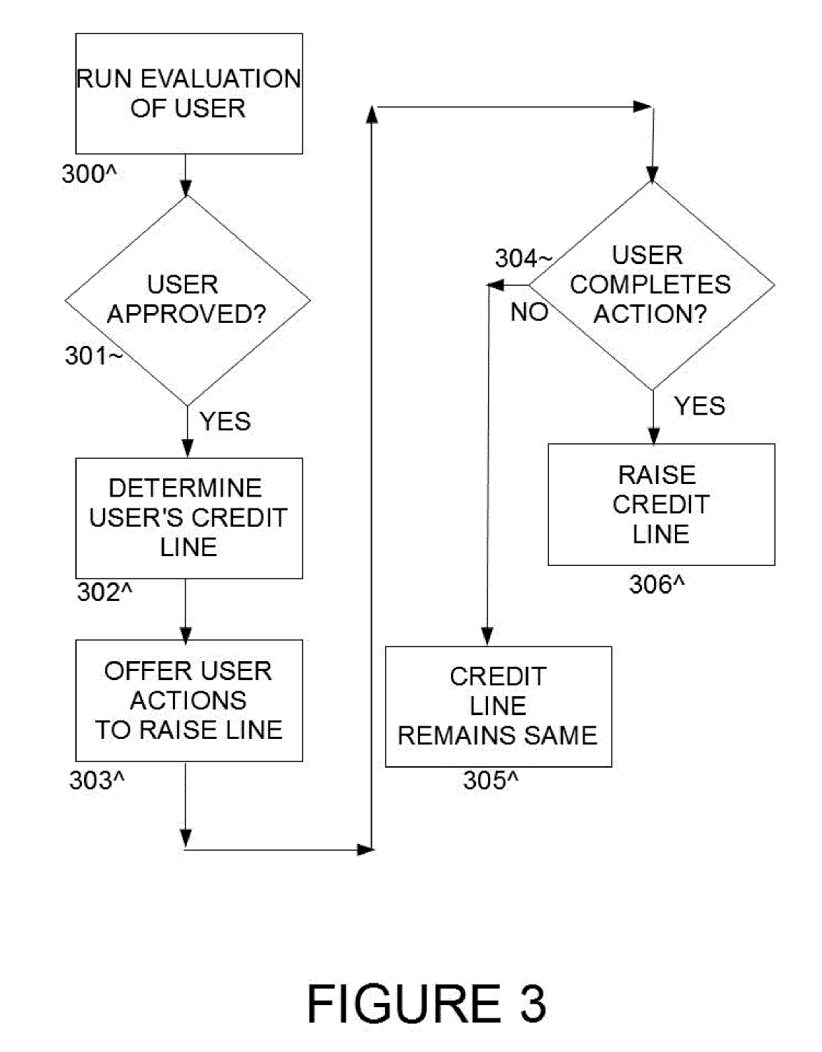

FIG. 3 is a flowchart illustrating an exemplary method of allowing a user to raise their cash line, according to an embodiment.

The method can begin with operation 300, which runs an evaluation of the user to determine whether to approve the offer of a cash line by a cash provider to the user. This can be done as known in the art or explained in the documents that are incorporated by reference. The cash line is an amount that the cash provider is willing to provide to the user as an advance or a loan, the amount being chosen by the user (up to the amount of the cash line). The money can be requested and received from the cash provider all at one time or in different intervals, so long as the total cash received by the user does not exceed the user's total cash line. The cash line also comes with terms of repayment to which the user will have to agree to, which includes repayment terms, interest, penalties for non-repayment, etc. or terms related to a cash advance, such as term, additional receivables due and penalties for failure to deliver the accounts receivable to the cash provider. As used herein, “repay” or “repayment” can include repayment in the context of a loan or the delivery of accounts receivable in the context of a merchant cash advance. The cash line can be considered a loan or advance wherein the user can take money off the cash line but of course the user is obligated to repay the money taken (plus interest or additional receivables as agreed). For example, the cash provider may charge an annual interest amount (or additional receivables) of 10% (or any other amount) for cash taken from the user's cash line (the interest of which can be computed daily). Note that when it is stated herein that there are “additional receivables” of some amount owed, it can also be viewed as the cash provider providing cash to the merchant at a discount—e.g. $9,000 for $10,000 of receivables. The cash provider is providing a service to the user for profit, meaning that the cash provider would typically profit from providing the cash line to users by receiving the money advanced back plus interest (or surcharges, etc.) from the user.

From operation 300, the method proceeds to operation 301, which determines if the user is approved for the cash line or not. If the user is not approved (not pictured), then the cash provider does not issue a cash line to the user (the user is declined) and the method ends.

If in operation 301, the user is approved, then the method proceeds to operation 302 which determines the user's cash line. The cash line can also be determined as known in the art or explained in the documents that are incorporated by reference. Operation 302 can also optionally be combined into operation 300 (the user's approval also generates the cash line).

When the user is approved and his or her cash line is determined, then the approval and the cash line are typically transmitted to the user (e.g., via email, paper mail, web page, etc.)

From operation 302, the method proceeds to operation 303, which offers the user actions to raise their cash line. FIG. 2 illustrates one way this offer can be made to the user, by displaying the offer on the user's output device (either via an email message, a web site, or other communication). Actions that a user can take to raise their cash line can include: friending a cash provider (actually a page associated with the cash provider) on a social networking site such as FACEBOOK or GOOGLE+; following the cash provider on a social networking site such as TWITTER; connecting to the cash provider (actually a page associated with the cash provider) on a social networking site such as LINKEDIN; providing an email address for a friend who may be interested in receiving their own cash line and having that friend actually sign up with the cash provider (and optionally being approved for a cash line and/or taking cash from the cash line); and any other way which involves actions the user can take using their accounts on social networking sites (or the cash provider's own web site) to provide additional information, publicity or users to the cash provider.

From operation 303 the method proceeds to operation 304, which determines if the user completed the action (any of the actions offered to the user). If the user did not complete the action, then the method proceeds to operation 305 wherein the user's cash line remains the same.

If in operation 304 it is determined that the user did complete the action, then the method proceeds to operation 306 wherein the cash provider raises the user's cash line. This can be done by adjusting (using software) the respective value representing the user's cash line in a database used by the cash provider to the new (increased) cash line.

Unless prohibited by the cash provider, the user would be permitted to exploit all possible ways the cash provider has offered to the user to raise the user's cash line. For example, if the cash provider offers three ways to raise the cash line (at $200 each) and a user completes two of these three ways, then the user's cash line would be increased by $400.

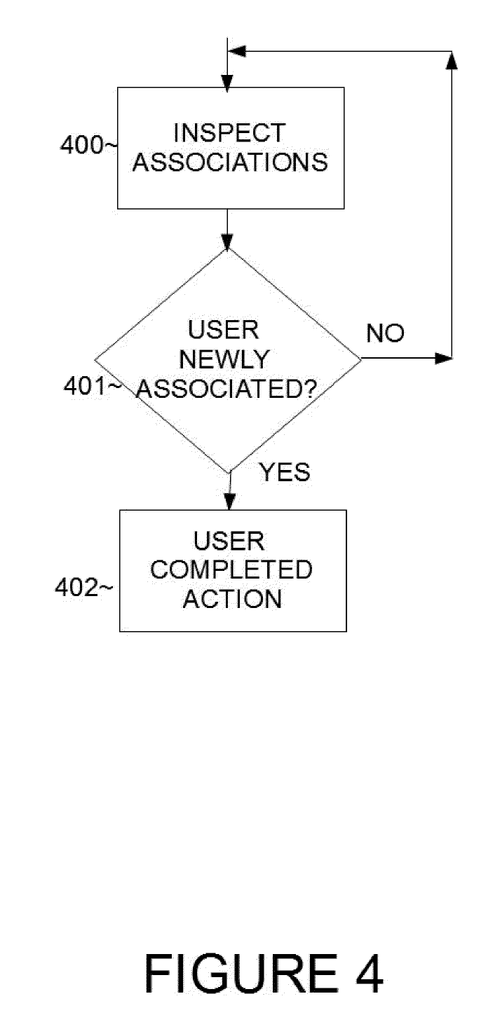

FIG. 4 is a flowchart illustrating a method of determining if a user associated one of their social networking accounts with the cash provider, according to an embodiment. FIG. 4 can be used in place of operation 304 from FIG. 3.

The method can begin with operation 400 which inspects associations. This can comprise retrieving a list of associations from a social networking site to determine the associations. For example, all people on FACEBOOK that like a particular page associated with the cash provider can be downloaded to the cash provider (or other server) running a program to effectuate the automatic cash line increases.

From operation 400, the method proceeds to operation 402 which evaluates the list of associations of the cash provider to see if there are new entries. For example, on FACEBOOK, every person who likes the cash provider's page can be compared with a prior list of person who liked the cash provider's page, and the new people are the ones who liked the page. Alternatively, all people on the list (people who like the cash providers page) can be compared to a list of people who are eligible for the cash line increase (those who have been given the offer to raise their cash line in this manner) and for those (if any) people who register as liking the cash provider page, they will be given the cash line increase (and their account will note this fact so they will not be given the same cash line increase again). In another embodiment the associations of the user himself/herself can be inspected (in operation 400) to see (operation 402) if their profile (or account information) indicates that they have liked the cash provider (technically a page associated with the cash provider).

If in operation 401, a particular user has been associated with the cash provider (to satisfy the terms of the offer to raise the cash line which can require the user to associate using any of the methods described herein) and the user has not already been given the cash line increase for the same association, then the method proceeds to operation 402 in which it is concluded that the user has completed the action. After operation 402 the method can return to operation 400 and continue inspecting for new associations.

If in operation 401, the user is not newly associated, then the method returns to operation 400 in which the system can continue to inspect associations (this can happen periodically, e.g., every minute, hour, day, etc.) In another embodiment, instead of inspecting associations periodically, as soon as a new association is generated on a social networking site, an alert is generated which then causes the system to determine if the new association was with a person that should trigger a cash line increase (e.g., that person received an offer to raise their cash line for making the type of association that was generated) and if so, then it would result in operation 402 (a conclusion that the user completed the action required to earn a cash line increase).

It is noted that if a user takes an opposite action after receiving the cash line increase, then the cash line may be (depending on the cash provider's rules) reduced by the same amount of the increase. For example, if Jane earned a $100 cash line increase by friending the cash provider, and subsequently unfriends the cash provider, then Jane's cash line would be reduced by the $100 (putting it back where it was originally).

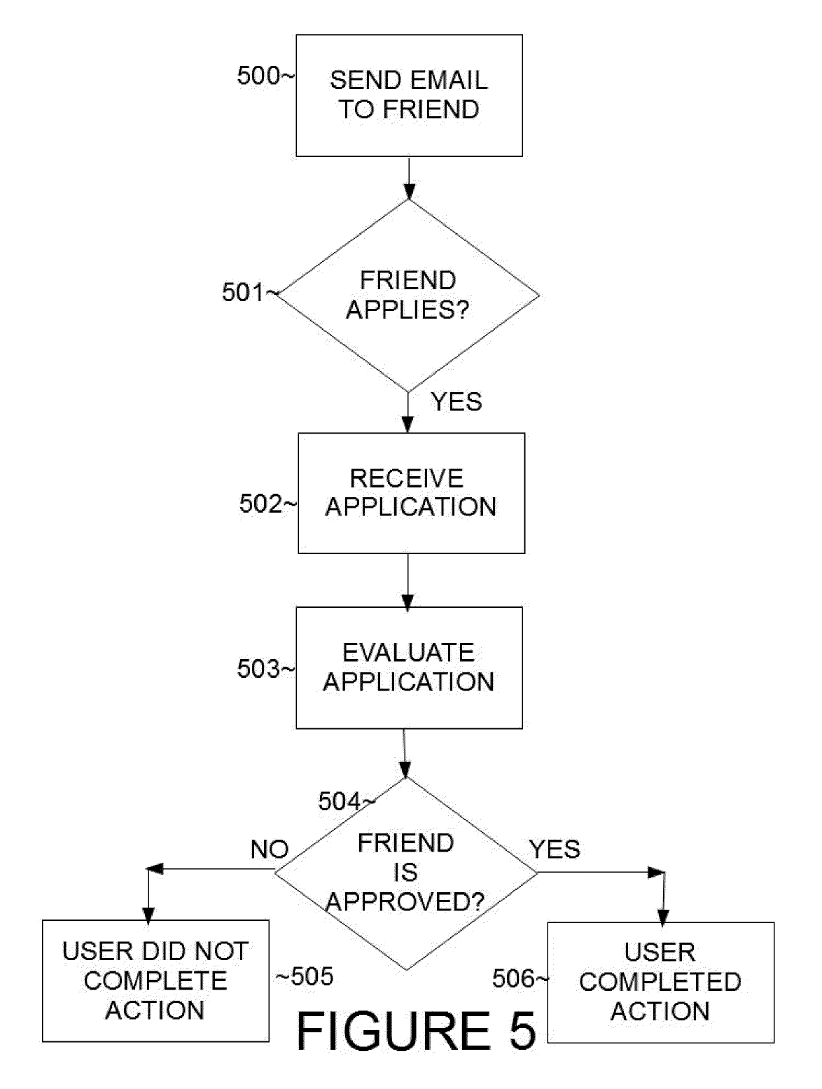

FIG. 5 is a flowchart illustrating a method of determining if a user's referral email address satisfies a sequence to complete an action thereby raising a cash line, according to an embodiment. FIG. 5 is implemented for each friend (referral) email address that the user enters in order to complete operation 304 from FIG. 3.

The method can begin with operation 500, which sends an introductory email to a friend entered by the user (actually the email is sent to the email address of the friend that was referred). The introductory email typically would introduce the cash provider to the friend and provide a link that the user can click if the user is interested in applying for a cash line.

If the user clicks the link (operation 501) then the user's browser would typically bring the user to an online application page where the user can apply for a cash line in operation 502 (see for example, FIGS. 9-10 and their accompanying description in application Ser. No. 13/175,184 for more information about the application process). The friend would typically be prompted to enter (and subsequently enter) his/her name, banking information, income information, and all other information needed for the application process.

Once the friend has completed the application in operation 502, then the method proceeds to operation 503 which evaluates the application to determine whether the friend is approved and how much of a cash line to offer the friend. This operation can be identical to the operations 300-302 in FIG. 3.

If in operation 504 the friend is not approved, then the method proceeds to operation 505 which results in the determination/conclusion that the user did not complete the action (at least for the email address used in operation 500), although the user may have submitted (or will submit) other referral email addresses (wherein the method in FIG. 5 will be implemented for each of those email addresses).

If in operation 504 the friend is approved, then the method proceeds to operation 506 which results in the determination/conclusion that the user did complete the action (for this one particular referral email address). Thus, the user would be entitled to whatever incentive was offered to the user for supplying a referral email address that would actually sign up (complete a required sequence in order to receive the incentive such as a cash line increase). The user may still be free to supply additional email addresses which can result in the user receiving additional incentives.

In an embodiment, before operation 506 is reached the friend would be required to actually receive cash from the cash provider (after being approved). To receive cash a user (such as the friend) would typically make a cash request against their cash line which results in cash being automatically electronically transferred to a bank account associated with the user. The cash provider may require that each referral actually receive cash before the referral triggers an incentive for the user who referred the referral. Otherwise, a user can exploit the cash provider by submitting numerous referrals of friends who register but do not receive cash from the cash provider, thus receiving incentives which do not necessarily benefit the cash provider (the cash provider benefits when people receive cash because they may be required to pay interest or some surcharge for the privilege of receiving the cash advance).

Thus, as illustrated in FIGS. 2 and 5, if the user refers the user's friends who then successfully complete an action, the user can receive an increase in the user's cash line. The following are various examples of how a user can earn an increase in their cash line: a) If the user refers five friends who sign up with the cash line provider, the user will receive a cash line increase of $100; b) if the user refers five friends who sign up with the cash line provider and actually receive a cash line, the user will receive a cash line increase of $50; c) For each friend the user refers who signs up with the cash line provider, the user will receive a cash line increase of $50; For each friend the use refers who signs up with the cash line provider and actually receives a cash line, the user will receive a cash line increase of $50; For each friend the user refers who “likes” (from their social networking account click a button which causes their profile or other information to display that the user likes (or associates with)) the cash provider page, the user will receive a cash line increase of $25; If the user refers 3 friends who “like” the cash provider page, the user will receive a cash line increase of $25. Of course, these are all merely examples and any other conditions can be used wherein the user refers their friends and then one or more of those friends successfully take particular action then the user will receive an incentive in the form of a cash line increase (or other incentive). The “cash provider page” is a page on a social networking site that is owned by, described, or is associated with the cash provider. For example, many business have their own pages on FACEBOOK, for example the BEST BUY company has their own BEST BUY page (with information about the company and their sales) on FACEBOOK which a user can find by searching for BEST BUY and once the page is displayed the user can click a “like” button on the BEST BUY page.

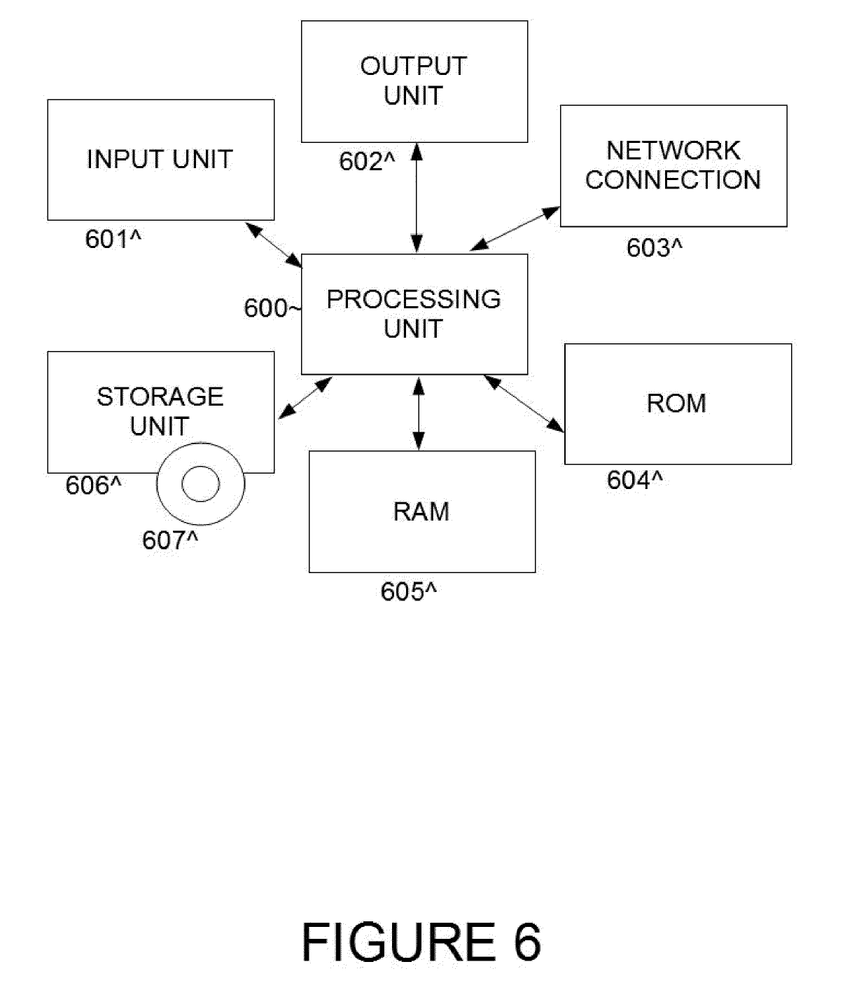

FIG. 6 is a block diagram illustrating components needed to implement a digital computer that can be used to implement the methods described herein, according to an embodiment. The computer can be for example, a server, a database, personal computer, cellular phone, tablet, any portable computing device, etc.

A processing unit (such as a microprocessor and associated structure e.g., bus, cache, etc.) is connected to an input unit 601 (e.g., keyboard, mouse, touch-screen display, etc.) and an output unit 602 (e.g., LCD display, touch-screen display, speaker, etc.) and a network connection 603 which allows the processing unit 600 to communication to/from a computer communications network such as the Internet. The processing unit 600 can also be connected to a ROM 604, RAM 605, and a storage unit 606 (e.g., hard disk drive, BLU-RAY drive, CD-ROM drive, etc.) which can read a computer readable storage medium 607 (e.g., disk, BLU-RAY disc, CD-ROM, EPROM, etc.). The computer readable storage medium 607, RAM 605, and/or ROM 604 can all store instructions (and other assets) which can implement any of the methods described herein.

All methods described herein can be performed on one or more electronic processors and/or computers working with each other. These processors/computers can be in the same or different physical locations connected by any type of computer communications network.

Anywhere “auction,” “e-auction,” “electronic auction” are used herein, other types of commerce sites can be used interchangeably, such as non-auction sites where items can be listed at a fixed price (e.g., CRAIGSLIST, AMAZON Stores, EBAY (non-auctions), etc.).

All features of documents that are incorporated by reference can be combined without limitation with each other and with features described in the text fully set forth herein. Features described herein can be combined with any feature(s) in the documents incorporated by reference without limitation.

It is noted that the order of any of the operations described herein can be performed in any order. Any operation described herein can also be optional. All flowcharts herein are not intended to illustrate the only possible implementation, and modifications and deviations can be added which include any feature described herein or based on well-established principles. For example, while endless loops may be theoretically possible in some flowcharts, in reality such situations could be handled using common sense approaches. Any embodiments herein can also be stored in electronic form and programs and/or data for such can be stored on any type of computer readable storage medium (e.g. CD-ROM, DVD, disk, etc.)

The descriptions provided herein also include any hardware and/or software known in the art and needed to implement the operations described herein. All components illustrated herein may also optionally communicate with any other component (either illustrated/described herein or not described but known in the art).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A computer implemented method, comprising:
performing, on one or more electronic processors, the following operations:
approving, by a cash provider, a user for a cash line wherein the user is permitted to receive cash up to the cash line;
causing an offer to be displayed on an electronic output device associated with a user's computer, the offer being to increase the cash line when the user takes a particular action comprising associating the user's social networking account with the cash provider;
determining that the user has taken the particular action; and
automatically increasing the cash line.

2. The method as recited in claim 1, wherein the particular action comprises the user using the user's FACEBOOK account to friend the cash provider.

3. The method as recited in claim 1, wherein the particular action comprises the user using the user's GOOGLE+ account to friend the cash provider.

4. The method as recited in claim 1, wherein the particular action comprises the user using the user's TWITTER account to follow the cash provider.

5. The method as recited in claim 1, wherein the particular action comprises the user using the user's LINKEDIN account to connect to the cash provider.

6. A computer implemented method, comprising:
performing, on one or more electronic processors, the following operations:
approving, by a cash provider, a user for a cash line wherein the user is permitted to receive cash up to the cash line;
causing an offer to be displayed on an electronic output device associated with a user's computer, the offer being to increase the cash line when a sequence is completed, the sequence comprising the user referring a friend of the user and the friend registering with the cash provider;
determining that the user has taken the particular action; and
automatically increasing the cash line.

7. The method as recited in claim 6, wherein the sequence further comprises the friend being approved for a cash line.

8. The method as recited in claim 7, wherein the sequence further comprises the friend receiving cash from the cash provider.

9. The method as recited in claim 6, wherein a predetermined plurality of friends of the user must complete the sequence before performing the automatically increasing the cash line.

10. A computer implemented method, comprising:
performing, on one or more electronic processors, the following operations:
approving, by a cash provider, a user for a cash line wherein the user is permitted to receive cash up to the cash line;
causing an offer to be displayed on an electronic output device associated with a user's computer, the offer being to increase the cash line when a sequence is completed, the sequence comprising the user referring a friend of the user and the friend successfully completing a sequence;
determining that the user has taken the particular action;
determining that the friend successfully completed the sequence; and
automatically increasing the cash line of the user.

11. The method as recited in claim 10, wherein the sequence is the friend liking a page associated with the cash provider.

12. The method as recited in claim 10, wherein the sequence is the friend registering with the cash provider.

13. The method as recited in claim 10, wherein the sequence is the friend registering with the cash provider and receiving a cash line.

14. The method as recited in claim 10, wherein the sequence must be completed a predetermined number of times by a different respective friend of the user before performing the automatically increasing the cash line of the user.
